(19) United States
(12) Patent Application Publication
(10) Pub. No.: US 2018/0063914 A1
(43) Pub. Date: Mar. 1, 2018

(54) MICRO DIMMING MODULE

(71) Applicant: UNITY OPTO TECHNOLOGY CO., LTD., NEW TAIPEI CITY (TW)

(72) Inventors: CHIH-HSIEN WU, NEW TAIPEI CITY (TW); WEI CHANG, NEW TAIPEI CITY (TW); KAI-CHENG CHUANG, NEW TAIPEI CITY (TW); SZU-CHIEN CHEN, NEW TAIPEI CITY (TW)

(21) Appl. No.: 15/363,246

(22) Filed: Nov. 29, 2016

(30) Foreign Application Priority Data
Aug. 23, 2016 (TW) 105126903

(51) Int. Cl. H05B 33/08

(52) U.S. Cl. CPC H05B 33/0845; H05B 33/0806

(57) ABSTRACT

A micro dimming module for driving at least one LED and supporting a TRIAC dimmer to linearly adjust the illumination of the LED comprises a light board, a rectifier and a controller. The light board is a circuit board with a diameter less than or equal to 3 cm or a side length less than or equal to 3 cm, and the rectifier is built without a RC circuit. Namely, the TRIAC dimmer is capable of remaining in a stable working condition without requiring the RC circuit to supply a holding current, so that the lighting application has the advantages of minimizing volume and accomplishing high adaptability and applicability.

### CROSS-REFERENCE TO RELATED APPLICATIONS

This non-provisional application claims priority under 35 U.S.C. §119(a) on Patent Application No(s). 105126903 filed in Taiwan, R.O.C. on Aug. 23, 2016, the entire contents of which are hereby incorporated by reference.

### FIELD OF THE INVENTION

The present invention relates to the field of photoelectric source circuit device, and more particularly to a micro dimming module of a Tri-Electrode Alternate Current (TRIAC) switch to linearly adjust the illumination of a Light Emitting Diode (LED).

### BACKGROUND OF THE INVENTION

### 1. Description of the Related Art

At present, a dimming control circuit is applied in various applications of lighting equipments to cope with the requirements of changing the illumination in different occasions for places such as stages, cinemas, or conference rooms or comply with the requirements of power saving and environmental protection, so as to achieve the effect of automatically adjusting the amount and distribution of lighting in a multilayer manner. For instance, an LED lamp generally adopts a constant current circuit design and uses a phase control component such as a Silicon Controlled Rectifier (SCR) or a TRIAC to change the voltage phase of an input power. The magnitude of output current is changed by switching the conduction angle of an input signal, so that the amount of driving current flowing into the LED can be adjusted to achieve a dimming effect. Although such dimming circuit has the advantages of simple control and easy and convenient installation, yet the voltage waveform of the input power is distorted to give rise to the issues of low PF and high voltage harmonics. According to the current/voltage (I/V) curve of the LED, LED is a nonlinear component. In other words, the ratio of voltage to current is not directly proportional. Therefore, the aforementioned dimming method has an imprecise dimming effect since the changes of driving voltage and driving current are inconsistent. As a result, power is wasted. With the influence by the characteristic of the TRIAC component, if the operating voltage flowing into the control circuit is too low, the current flowing through the TRIAC will be insufficient for operation, so that the operation modes of the TRIAC will be switched repeatedly, and the driving current will be discontinuous, and the LED will blink, and the lighting quality will be affected adversely. On the other hand, if the operating voltage flowing into the control circuit is too high, the high/low level voltage change of a Pulse Width Modulation (PWM) signal will be too fast, and noises and interferences will be formed, and the LED will be operated abnormally, and the applicability of the LED will be reduced.

To overcome the aforementioned drawbacks, a conventional LED lamp 1 having a TRIAC dimmer 10 as shown in FIG. 1 is provided, and the conventional LED lamp 1 comprises a rectifier 11, a controller 12, and a holder 13 installed between the TRIAC dimmer 10 and the rectifier 11, and the holder 13 is formed by connecting a capacitor (C) 130 to a resistor (R) 131 in series. When the TRIAC dimmer 10 receives an external AC voltage to adjust a phase conduction angle of the AC voltage, the rectifier 11 rectifies the AC voltage and drives the controller 12 to change the magnitude of a driving current (ILED) and output the driving current to at least one LED 2, so as to achieve a dimming effect. In the meantime, the holder 13 forms a hold current (Ihold) by the charge/discharge of the capacitor 130 and the power consumption of the resistor 131, and the hold current (Ihold) is supplied to the TRIAC dimmer 10 to ensure its normal operation and prevent the occurrence of strobe of the LED lamp 1. Although such circuit architecture using the RC circuit to generate the hold current is capable of stabilizing the operation of the TRIAC simply and effectively, yet persons having ordinary skill in the art should know that a large volume of the RC component is really not conducive to miniaturization and hinders the development and application of the products

Based on the aforementioned drawbacks of the prior art, it is a main subject of the present invention to make the rectifier 11 or the controller 12 to have the TRIAC current support function for a high dimming stability while reducing the total volume of the circuit without requiring the use of the holder 13, so as to facilitate the miniaturization of electronic products and comply with the requirements of industrial applications.

### 2. Summary of the Invention

Therefore, it is a primary objective of the present invention to provide a micro dimming module capable of stabilizing the operation of the TRIAC without requiring a RC circuit, so as to prevent the issues of a strobe or a noise caused by a too low or too high dimming frequency.

To achieve the aforementioned and other objectives, the present invention provides a micro dimming module for driving at least one LED and supporting a TRIAC dimmer to linearly adjust the illumination of the LED, comprising: a light board, being a circuit board with a diameter less than or equal to 3 cm or a side length less than or equal to 3 cm; a rectifier, installed on the light board, and electrically coupled to an external power supply through the TRIAC dimmer, for outputting a rectified voltage after receiving an AC voltage, and the TRIAC dimmer requiring no electrically coupled RC circuit; and a controller, installed on the light board, and electrically coupled to the rectifier and the LED, and having a controller chip and a holding resistor, such that while the controller is receiving the rectified voltage to output a driving voltage to the LED, the controller chip uses the holding resistor to output a hold current to the rectifier to ensure the working stability of the TRIAC dimmer.

Wherein, the controller chip has a built-in metal oxide semiconductor field effect transistor (MOSFET), and when the controller receives the rectified voltage, the controller chip uses the MOSFET and the holding resistor to output the hold current.

In addition, the controller further has a sensing resistor and an output capacitor electrically coupled to the LED, and the output capacitor is a multilayer ceramic capacitor. The controller chip has a plurality of pins including a drain pin, a source pin, and a compensation pin, and the source pin is electrically coupled to the sensing resistor, and the drain pin is electrically coupled to the output capacitor, and the compensation pin is electrically coupled to the rectifier through the holding resistor, so that after the controller chip detects the magnitude of the driving voltage through the source pin and the drain pin, the magnitude of the hold current is adjusted and outputted through the compensation pin.

In summation, the present invention simply uses the field effect transistor to provide the required operating current of the TRIAC dimmer and prevent the whole circuit from having abnormal current surge of voltage imbalance during the dimming process to improve the quality and stability of the operation. Even more unusual is that no RC circuit is used for supplying the hold current. With reference to FIGS. 1 to 3, a one-dollar coin (Chinese coin), a quarter (United States coin), and a 10-yen coin (Japanese coin) are used as a scale for comparison. The actual circuit module of the present invention at the lower left side is much smaller than the two conventional dimming modules at the upper left sides and the upper right sides respectively. The volume can be minimized as shown in FIG. 4, and the area of the actual circuit module of the micro dimming module is almost smaller than a one-dollar coin (Taiwan) with a diameter approximately equal to 2 cm, and the adaptability of the module is improved significantly. What is more, the invention has the advantages of simple structure and few components, and thus the component and manufacturing costs are low.

### BRIEF DESCRIPTION OF THE DRAWINGS

FIG. 1 is a circuit diagram of a conventional LED lamp having a TRIAC dimmer;

FIG. 2 is a block diagram of a preferred embodiment of the present invention;

FIG. 3 is a circuit diagram of a preferred embodiment of the present invention;

FIG. 4 is a perspective view of a first implementation mode in accordance with a preferred embodiment of the present invention;

FIG. 5 is a perspective view of a second implementation mode in accordance with a preferred embodiment of the present invention; and

FIG. 6 is a photograph demonstrating the relative size of a preferred embodiment of the present invention relative to a quarter dollar coin of the United States.

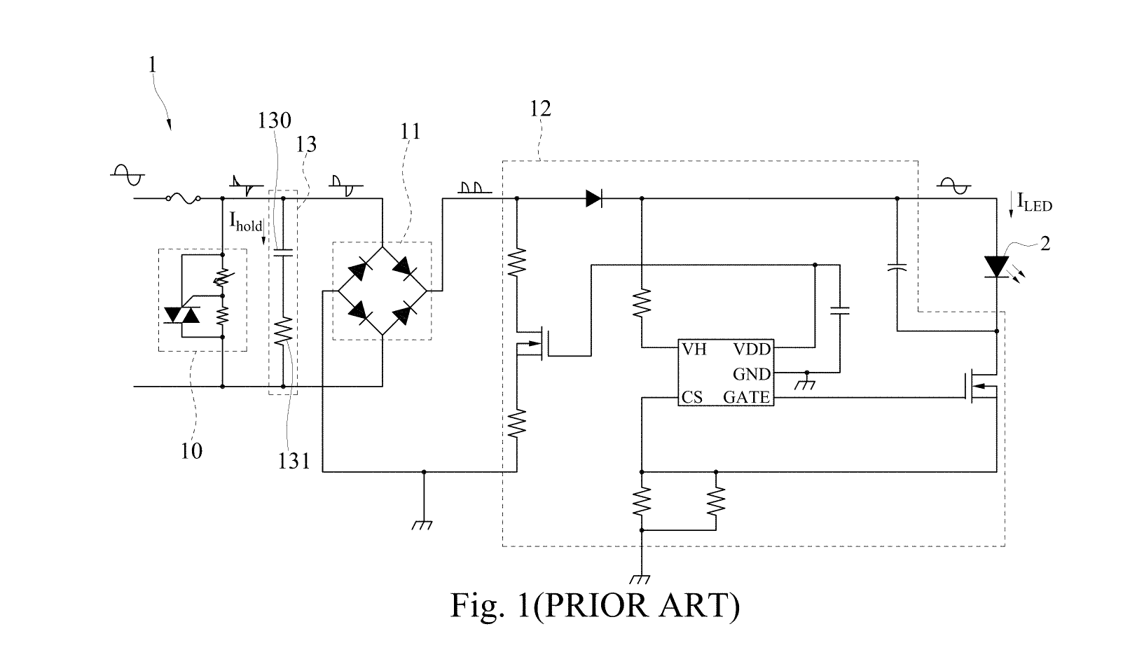

### DESCRIPTION OF THE PREFERRED EMBODIMENTS

The above and other objects, features and advantages of this disclosure will become apparent from the following detailed description taken with the accompanying drawings.

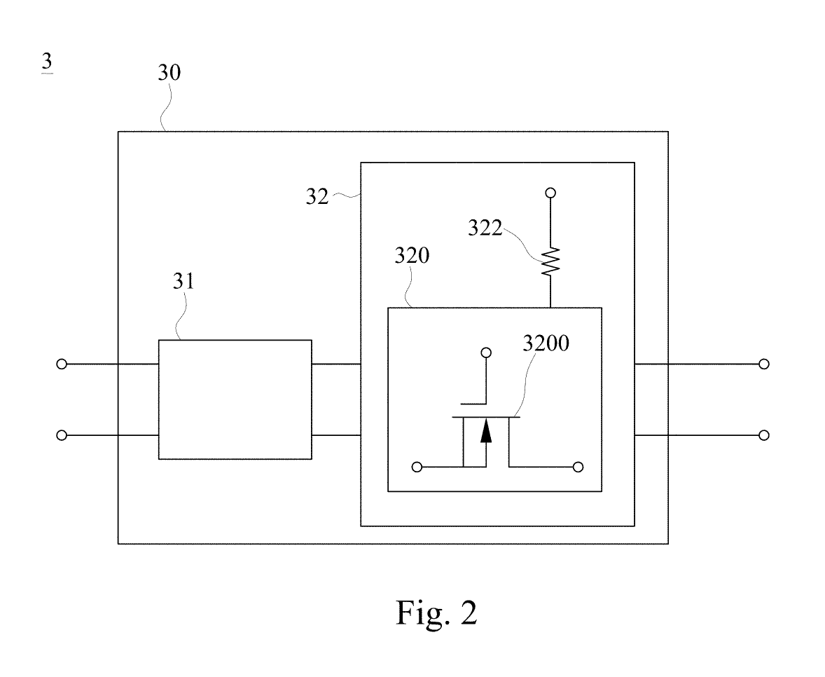

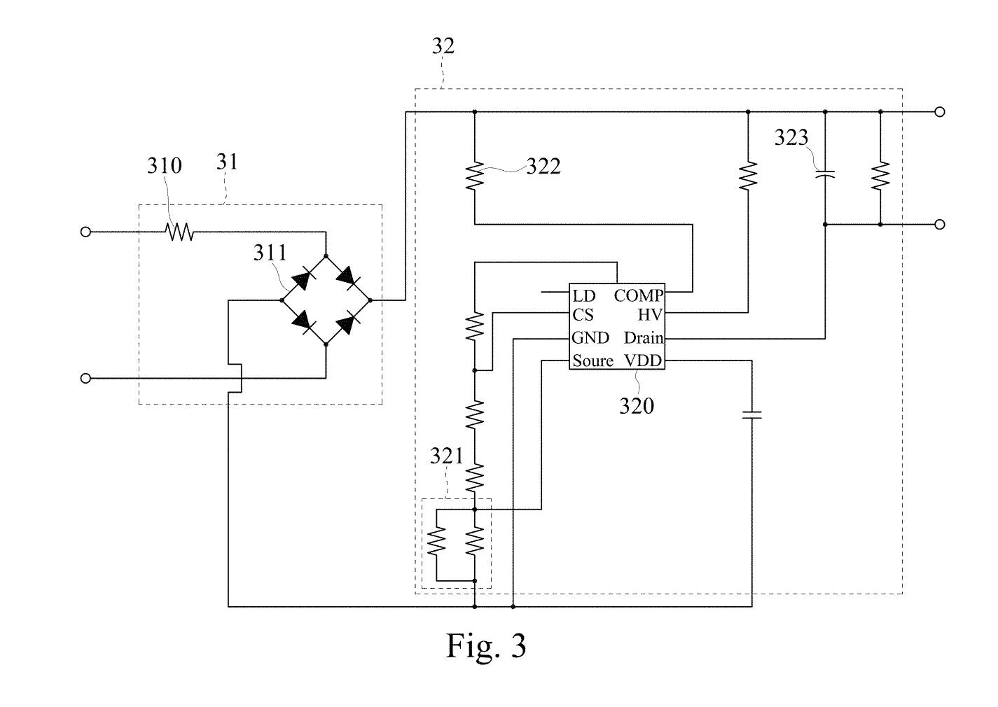

With reference to FIGS. 2 and 3 for the block diagram and the circuit diagram of a preferred embodiment of the present invention respectively, the micro dimming module 3 is installed in an LED lamp (not shown in the figure) for driving at least one LED (not shown in the figure) and supporting a TRIAC dimmer (not shown in the figure) to linearly adjust the illumination brightness of the LED. The micro dimming module 3 comprises a light board 30, a rectifier 31 and a controller 32, and the rectifier 31 is consisted of a protective resistor 310 and a full-wave bridge rectifier 311 without any RC circuit, and the controller 32 comprises a controller chip 320, a sensing resistor 321, a holding resistor 322 and an output capacitor 323, and the controller chip has a built-in MOSFET chip 3200 and at least includes a sensing pin (CS), a source pin (Source), a drain pin (Drain) and a compensation pin (COMP).

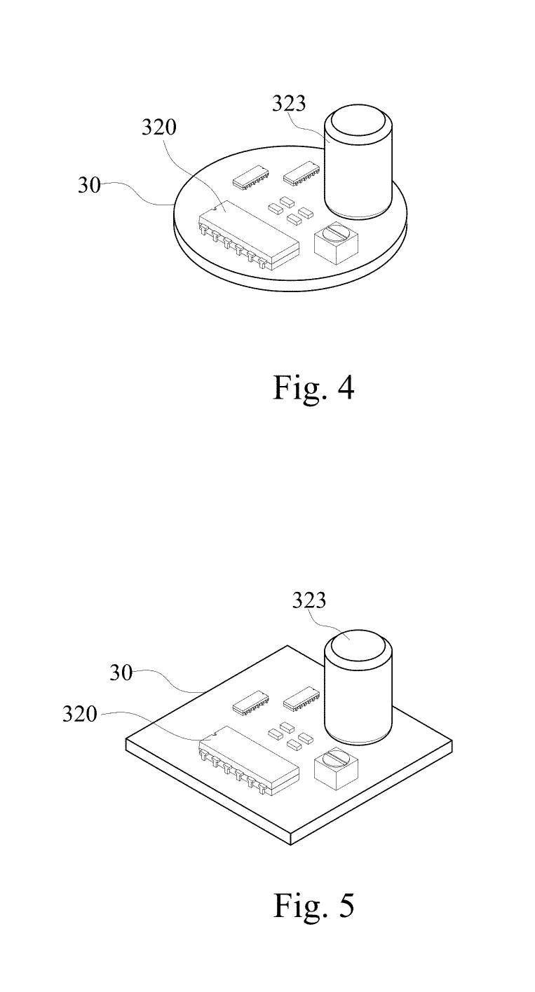

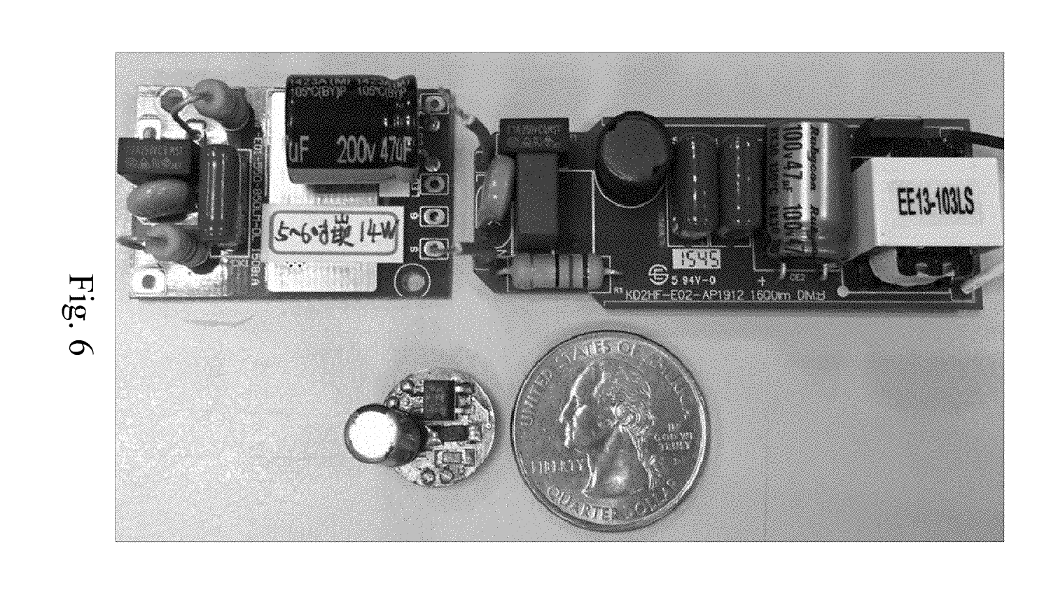

The output capacitor 323 is a multilayer ceramic capacitor, and the light board 30 is a circuit board with a diameter less than or equal to 3 cm or a side length less than or equal to 3 cm, such as a circular circuit board with a diameter of 2.8 cm, 2.6 cm, 2.2 cm, 1.8 cm, 1.5 cm or 1 cm as shown in FIG. 4, or a square circuit board with a diameter 2.9 cm, 2.5 cm, 2.1 cm, 1.7 cm, 1.3 cm or 0.9 cm as shown in FIG. 5. The rectifier 31 and the controller 32 are installed on the light board 30, and the rectifier 31 is electrically coupled to the controller 32 and also electrically coupled to an external power supply (not shown in the figure) through the TRIAC dimmer. The compensation pin of the controller chip 320 is electrically coupled to the full-wave bridge rectifier 311 through the holding resistor 321, and the drain pin is electrically coupled to the LED through the output capacitor 323, and the source pin is electrically coupled to the sensing resistor 321. It is noteworthy that the TRIAC dimmer is not required to be electrically coupled to the RC circuit.

When the full-wave bridge rectifier 311 receives an AC voltage of the external power supply through the protective resistor 310, the rectifier 31 rectifies and outputs a rectified voltage to the controller 32. The controller 32 uses the rectified voltage to form a driving voltage, and then outputs the driving voltage to the LED, while the controller chip 320 detects the magnitude of the driving voltage through the source pin and the drain pin, and then adjusts the MOSFET 3200, and outputs a compensation voltage through the compensation pin to the holding resistor 321, so that the holding resistor 321 forms a hold current by receiving a voltage drop, and outputs the hold current to the rectifier 31 to ensure the stability of operation of the TRIAC dimmer. With a very small volume, the lamp still has high operation quality and dimming stability and will not have abnormal current surge or voltage imbalance during the dimming process. Therefore, the invention improves the adaptability and applicability of the micro dimming module 3 and even the lamp significantly.

1. A micro dimming module, for driving at least one LED and supporting a TRIAC dimmer to linearly adjust the illumination of the LED, comprising a light board, a rectifier, installed on the light board, and electrically coupled to an external power supply through the TRIAC dimmer, for outputting a rectified voltage after receiving an AC voltage, and a controller, installed on the light board, and electrically coupled to the rectifier and the LED, and having a controller chip and a holding resistor, characterized in that:
the light board is a circuit board with a diameter less than or equal to 3 cm or a side length less than or equal to 3 cm;
the controller chip has a built-in MOSFET chip which includes a sensing pin, a source pin, a drain pin, and a compensation pin,
the TRIAC dimmer does not require electrically coupling to a RC circuit; and
while the controller is receiving the rectified voltage to output a driving voltage to the LED, the controller chip uses the holding resistor to output a hold current to the rectifier to ensure the working stability of the TRIAC dimmer,
wherein, after the controller receives the rectified voltage, the controller chip uses a field effect transistor and the holding resistor to output the hold current.

2. (canceled)

3. The micro dimming module according to claim 2, wherein the controller further includes a sensing resistor and an output capacitor, and the output capacitor is electrically coupled to the LED.

4. The micro dimming module according to claim 3, wherein the source pin of the controller chip is electrically coupled to the sensing resistor, and the drain pin of the controller chip is electrically coupled to the output capacitor, and the compensation pin of the controller chip is electrically coupled to the rectifier through the holding resistor, so that the controller chip detects a magnitude of the driving voltage, and then adjusts a magnitude of the outputted hold current through the compensation pin.

5. The micro dimming module according to claim 3, wherein the output capacitor is a multilayer ceramic capacitor.
